(19) United States
(12) Patent Application Publication
(10) Pub. No.: US 2018/0035365 A1
(43) Pub. Date: Feb. 1, 2018

(54) SYSTEMS AND METHODS FOR PROVIDING A NETWORK SEARCH OPTION

(71) Applicant: QUALCOMM Incorporated, San Diego, CA (US)

(72) Inventors: Praveen Koratekere Honnappa, San Diego, CA (US); Yashavant Anuse, San Diego, CA (US); Ramesh Venkatachalam, San Diego, CA (US); Venkata Maddisetty, San Diego, CA (US)

(21) Appl. No.: 15/225,374

(22) Filed: Aug. 1, 2016

(51) Int. Cl. H04W 48/16

(52) U.S. Cl. CPC H04W 48/16; H04W 84/12

(57) ABSTRACT

A method is described. The method includes receiving a user request for a search via a WiFi user interface (UI) search option that facilitates searches for one or more available WiFi networks satisfying one or more user-specified criteria. The method also includes searching with the WiFi UI search option a list of available WiFi networks found during a most recent scan based on the user-specified criteria. The method further includes displaying with the WiFi UI a search result comprising one or more WiFi networks of the available WiFi networks that satisfy the one or more user-specified criteria.

### TECHNICAL FIELD

The present disclosure relates generally to communications. More specifically, the present disclosure relates to systems and methods for providing a network search option.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or more reliably are often sought after.

Advances in technology have resulted in smaller and more powerful wireless communication devices. For example, there currently exist a variety of wireless communication devices such as portable wireless telephones (e.g., smartphones) personal digital assistants (PDAs), laptop computers, tablet computers and paging devices that are each small, lightweight, and can be easily carried by users. More specifically, the wireless communication devices may include cellular transceivers that communicate voice and data packets over wireless networks. Further, such devices are being manufactured to enable communications using a variety of communication technologies. For example wireless communication devices may perform cellular communications, WiFi communications (also referred to as wireless local area network (WLAN) communications), near field communication (NFC), fiber optic communication, etc.

A wireless communication device may include a WiFi user interface (UI). A list of available WiFi networks may be displayed in the WiFi UI to enable a user to select a WiFi network to join. However, as the number of WiFi networks increases, it may become cumbersome for the user to find a particular WiFi network in the list of available WiFi networks. Furthermore, the user may wish to search for a WiFi network based on a parameter other than the network name. As can be observed from this discussion, systems and methods for providing a network search option in a WiFi UI may be beneficial.

### SUMMARY

A method is described. The method includes receiving a user request for a search via a WiFi user interface (UI) search option that facilitates searches for one or more available WiFi networks satisfying one or more user-specified criteria. The method also includes searching with the WiFi UI search option a list of available WiFi networks found during a most recent scan based on the user-specified criteria. The method further includes displaying with the WiFi UI a search result comprising one or more WiFi networks of the available WiFi networks that satisfy the one or more user-specified criteria.

The method may also include initiating a new scan for available WiFi networks in response to receiving the user request for the search. Searching the list of available WiFi networks found during a most recent scan may include searching a list of available WiFi networks found during the new scan initiated by the user request for the search. Initiating the new scan may include invoking a supplicant entity of a WiFi-enabled wireless communication device to trigger the new scan.

The method may also include receiving at the WiFi UI a notification that new scan results are available. The search result may be refreshed based on the new scan results.

The user-specified criteria may include a network name. The user-specified criteria may include at least one of a band, a channel or a type of security used by a WiFi network.

Searching the list of available WiFi networks based on the user-specified criteria may include filtering WiFi networks in the list of available WiFi networks to remove those that do not satisfy the one or more user-specified criteria.

A wireless communication device is also described. The wireless communication device includes a processor, a memory in communication with the processor and instructions stored in the memory. The instructions are executable by the processor to receive a user request for a search via a WiFi UI search option that facilitates searches for one or more available WiFi networks satisfying one or more user-specified criteria. The instructions are also executable to search with the WiFi UI search option a list of available WiFi networks found during a most recent scan based on the user-specified criteria. The instructions are further executable to display with the WiFi UI a search result comprising one or more WiFi networks of the available WiFi networks that satisfy the one or more user-specified criteria.

A computer-program product for wireless communications is also described. The computer-program product includes a non-transitory computer-readable medium having instructions thereon. The instructions include code for causing a wireless communication device to receive a user request for a search via a WiFi UI search option that facilitates searches for one or more available WiFi networks satisfying one or more user-specified criteria. The instructions also include code for causing the wireless communication device to search with the WiFi UI search option a list of available WiFi networks found during a most recent scan based on the user-specified criteria. The instructions further include code for causing the wireless communication device to display with the WiFi UI a search result comprising one or more WiFi networks of the available WiFi networks that satisfy the one or more user-specified criteria.

### BRIEF DESCRIPTION OF THE DRAWINGS

FIG. 1 is a block diagram illustrating a wireless communication system in which a network search option may be implemented;

FIG. 2 is a flow diagram illustrating one configuration of a method for providing a network search option;

FIG. 3 is an example illustrating a configuration of a WiFi user interface (UI);

FIG. 4 is an example illustrating a configuration of a WiFi UI with a search option;

FIG. 5 is an example illustrating another configuration of a WiFi UI with a search option;

FIG. 6 is a flow diagram illustrating another configuration of a method for providing a network search option;

FIG. 7 is a flow diagram illustrating yet another configuration of a method for providing a network search option; and

FIG. 8 illustrates certain components that may be included within a wireless communication device.

### DETAILED DESCRIPTION

Typically, a WiFi-enabled wireless communication device (e.g., mobile phone, tablet computer, personal computer) has a user interface (UI) that displays a list of available WiFi networks. Because of the growing deployment of WiFi networks (e.g., WiFi hotspots), the list of networks in the WiFi UI can be quite long. Also, the list of networks is periodically updated, and the positions of the various networks in the list can change due to changing signal strength, networks being added or removed, etc. In view of these factors, finding a desired network from the list of networks in the WiFi UI can be cumbersome for the user.

The systems and methods described herein add a search option to the WiFi UI. Most wireless communication device periodically scan for available networks. The UI obtains the scan results and displays the list of networks found during the scan. The described systems and methods allow the user to search for one or more WiFi networks in the list that satisfy one or more user-specified criteria. The user would not necessarily be limited to searching based on the network name, but could also search for other criteria, such as band, channel, type of security, etc.

There are at least three different ways that the search option could be implemented: (1) a static search, (2) a dynamic search that initiates a new scan, and (3) a dynamic search that does not initiate a new scan but refreshes the search result when new scan results are available. These different approaches are described in more detail below.

The systems and methods described herein may be implemented on a variety of different electronic devices. Examples of electronic devices include general purpose or special purpose computing system environments or configurations, personal computers (PCs), server computers, handheld or laptop devices, multiprocessor systems, microprocessor-based systems, programmable consumer electronics, network PCs, minicomputers, mainframe computers, distributed computing environments that include any of the above systems or devices and the like. The systems and methods may also be implemented in mobile devices such as phones, smartphones, wireless headsets, personal digital assistants (PDAs), ultra-mobile personal computers (UMPCs), mobile Internet devices (MIDs), etc. Further, the systems and methods may be implemented by battery-operated devices, sensors, etc. The following description refers to wireless communication devices for clarity and to facilitate explanation. Those of ordinary skill in the art will understand that a wireless communication device may comprise any of the devices described above as well as a multitude of other devices.

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

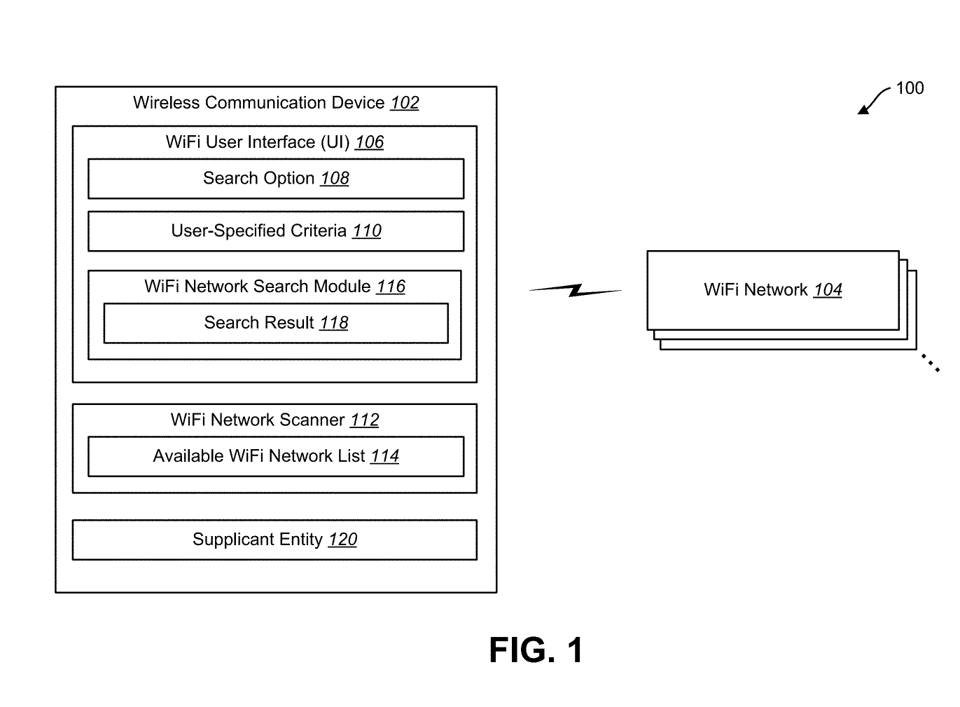

FIG. 1 is a block diagram illustrating a wireless communication system 100 in which a network search option may be implemented. The wireless communication system 100 may include a wireless communication device 102 and one or more WiFi networks 104. Wireless communication systems 100 are widely deployed to provide various types of communication content such as voice, data and so on.

A wireless communication device 102 may comprise other components not illustrated in FIG. 1. Those skilled in the art will understand that the wireless communication device 102 of FIG. 1 has been simplified to facilitate explanation.

Communications in the wireless communication system 100 may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. In some configurations, the wireless communication system 100 may utilize MIMO. A MIMO system may support time division duplex (TDD) and/or frequency division duplex (FDD) systems.

In some configurations, the wireless communication system 100 may operate in accordance with one or more standards. Examples of these standards include Bluetooth (e.g., Institute of Electrical and Electronics Engineers (IEEE) 802.15.1), IEEE 802.11 (Wi-Fi), IEEE 802.16 (Worldwide Interoperability for Microwave Access (WiMAX), Global System for Mobile Communications (GSM), Universal Mobile Telecommunications System (UMTS), CDMA2000, Long Term Evolution (LTE), etc. Accordingly, the wireless communication device 102 may communicate using a communication protocol such as WiFi in some configurations.

In some configurations, the wireless communication system 100 may be a multiple-access system capable of supporting communication with multiple wireless communication devices by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, General Packet Radio Service (GPRS) access network systems, 3rd Generation Partnership Project (3GPP) Long Term Evolution (LTE) systems, and spatial division multiple access (SDMA) systems.

In LTE and UMTS, a wireless communication device 102 may be referred to as a “user equipment” (UE). In 3GPP Global System for Mobile Communications (GSM), a wireless communication device 102 may be referred to as a “mobile station” (MS). The wireless communication device 102 may be referred to as and/or may include some or all of the functionality of a UE, MS, terminal, an access terminal, a subscriber unit, a station, etc. Examples of the wireless communication device 102 include cellular phones, smartphones, wireless headsets, wireless speakers, personal digital assistants (PDAs), wireless devices, electronic automobile consoles, gaming systems, wireless controllers, sensors, wireless modems, handheld devices, laptop computers, Session Initiation Protocol (SIP) phones, wireless local loop (WLL) stations, etc.

In an implementation, the wireless communication device 102 may be configured to communicate using WiFi. As used herein, a WiFi network 104 may also be referred to as a wireless local area network (WLAN).

The wireless communication device 102 may perform network operations by connecting to a WiFi network 104. For example, a WiFi-enabled wireless access point (WAP) may provide wireless connections using radio frequency (RF) resources allow the wireless communication device 102 to join the WiFi network 104. The WiFi network 104 may enable the wireless communication device 102 to communicate with other devices that are part of the WiFi network 104. Additionally, a WiFi network 104 may enable the wireless communication device 102 to connect to devices on other networks (e.g., the internet).

In WiFi communication, a WiFi network 104 may include one or more WiFi hotspots. A hotspot is a physical location where a wireless communication device 102 may gain access to the WiFi network 104 using WiFi technology. One or more WAPs may be used to implement a WiFi hotspot.

WiFi may operate in different radio frequency bands. For example, WiFi may operate in the 2.4 gigahertz (GHz) or 5 GHz ISM radio bands. Within each band, a WiFi signal may occupy one or more channels. For example, a Wi-Fi signal may occupy five channels in the 2.4 GHz band.

In some implementations, a WiFi network 104 may employ one or more types of security. For example, a WiFi network 104 may use wired equivalent privacy (WEP) encryption, Wi-Fi Protected Access (WPA), WPA2, etc. As part of these security protocols, the wireless communication device 102 may provide credentials (e.g., password) to the WiFi network 104 to gain access to the WiFi network 104. Communications may be encrypted using the one or more security protocols.

A particular WiFi network 104 may be identified by a network name (also referred to as a network identifier). In an implementation, a WiFi network 104 may identify itself using service set identifier (SSID). A WAP may broadcast the SSID of its WiFi network 104. A wireless communication device 102 that is in range of the WAP may receive the broadcast SSID and identify the WiFi network 104.

As part of WiFi communication, the wireless communication device 102 may scan for one or more WiFi networks 104 to join. For example, the wireless communication device 102 may include a WiFi network scanner 112 that may perform the WiFi network scan. The WiFi network scanner 112 may be implemented in hardware, software or a combination of hardware and software. The WiFi network scanner 112 may periodically scan the WiFi radio spectrum (e.g., WiFi bands and channels) to determine which WiFi networks 104 are in range. This may include receiving a broadcast signal from a WAP that includes the SSID of the WiFi network 104. The WiFi network scanner 112 may measure the received signal strength indicator (RSSI) of a WiFi signal to determine the strength and/or quality of the WiFi signal.

The WiFi network scanner 112 may generate an available WiFi network list 114. Upon performing the scan, the WiFi network scanner 112 may identify one or more WiFi networks 104 that are available to connect to by the wireless communication device 102. The available WiFi network list 114 may include one or more these available WiFi networks 104 identified in the most recent WiFi network scan. The WiFi network scanner 112 may update the WiFi networks 104 included in the available WiFi network list 114 after each scan.

The wireless communication device 102 may include a WiFi user interface (UI) 106. In an implementation, the WiFi UI 106 may be a part of the native operating system (OS) of the wireless communication device 102. In another implementation, the WiFi UI 106 may be an application or program that is installed to supplement the native OS of the wireless communication device 102.

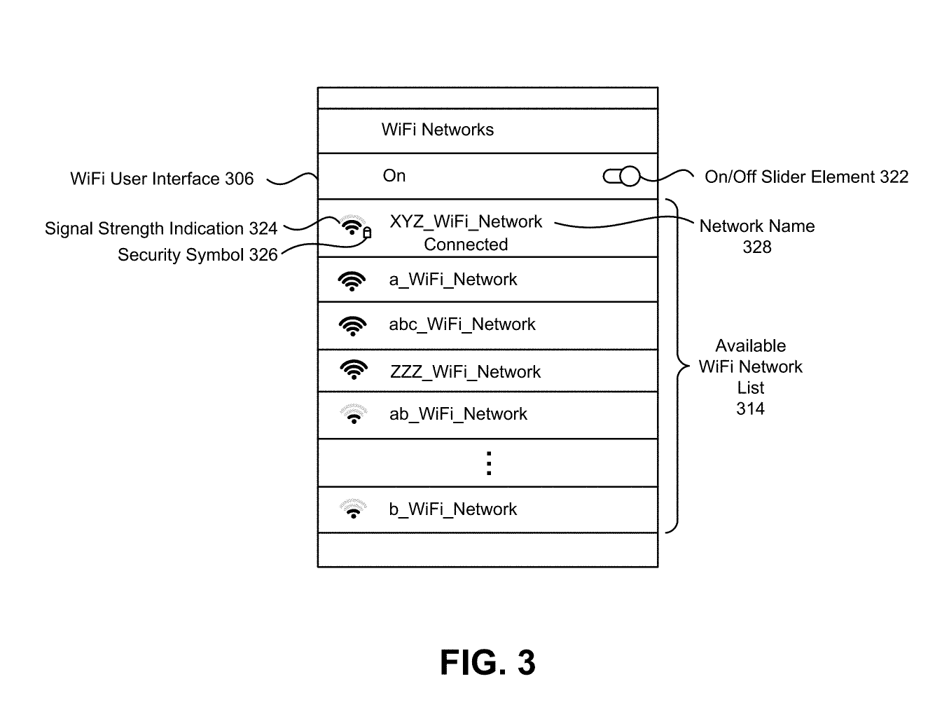

The WiFi UI 106 may display the available WiFi network list 114. For example, the WiFi UI 106 may display the network names (e.g., SSID) of the available WiFi networks 104. The WiFi UI 106 may also display additional information about the WiFi network 104. For example, the WiFi UI 106 may display the signal strength of the WiFi network 104 and whether the WiFi network 104 is secured. An example of a WiFi UI 106 is described in connection with FIG. 3.

A user may read through the displayed WiFi networks 104 and select a WiFi network 104 to join. Upon selecting the WiFi network 104, the wireless communication device 102 may attempt to establish a connection on the WiFi network 104.

In an implementation, the wireless communication device 102 may include a supplicant entity 120 that can initiate a WiFi network scan. The supplicant entity 120 may be a software implementation on the wireless communication device 102. The supplicant entity 120 may pass a scan trigger from a WiFi UI 106 of the wireless communication device 102 to the WiFi network scanner 112. The supplicant entity 120 may receive the available WiFi network list 114 from the WiFi network scanner 112 and may pass the available WiFi network list 114 to the WiFi UI 106.

In one configuration, the supplicant entity 120 may interact with the user level of the OS stack (e.g., the WiFi UI 106). The supplicant entity 120 may initiate a new trigger for a WiFi network scan. The supplicant entity 120 may pass the scan trigger to the host layer of the OS stack. The host layer may pass the scan trigger to the firmware layer, which in turn passes the scan trigger to the hardware layer to perform the WiFi network scan. The results of the scan may be passed up the OS stack back to the supplicant entity 120.

Because of the growing deployment of WiFi hotspots, the available WiFi network list 114 displayed in the WiFi UI 106 can be quite long. Also, the available WiFi network list 114 is periodically updated, and the positions of the various WiFi networks 104 in the available WiFi network list 114 can change due to changing signal strength, WiFi networks 104 being added or removed, etc. In view of these factors, finding a desired WiFi network 104 from the available WiFi network list 114 in the WiFi UI 106 can be cumbersome for the user.

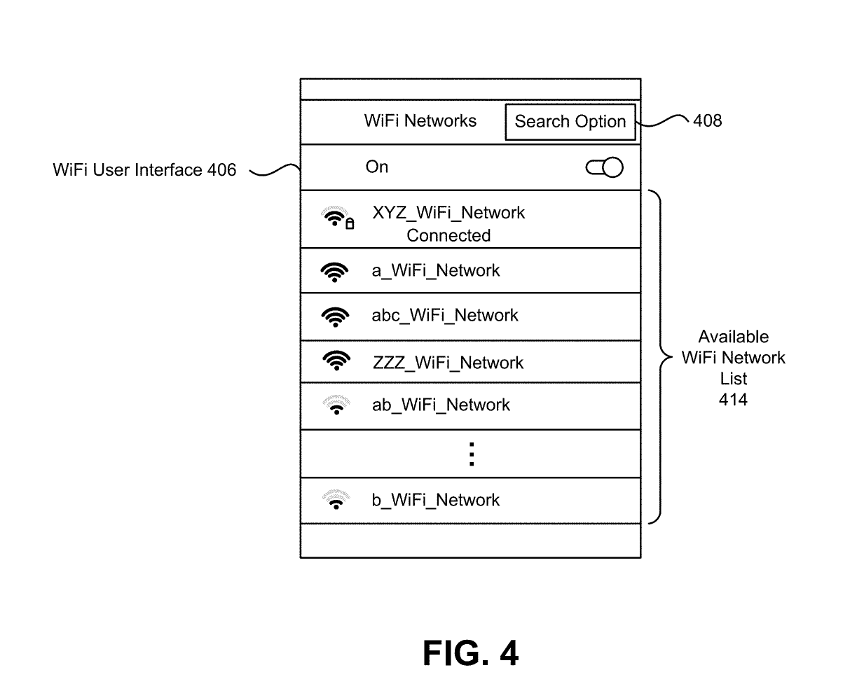

The systems and methods described herein provide a WiFi network search option 108 in the WiFi UI 106. A search option 108 may be added to the WiFi UI 106. One example of a WiFi UI 106 with this search option 108 is described in connection with FIG. 4.

The search option 108 may allow the user of the wireless communication device 102 to search for one or more WiFi networks 104 in the available WiFi network list 114 that satisfy one or more user-specified criteria 110. In an implementation, the user-specified criteria 110 include a network name (e.g., SSID). User-specified criteria 110 other than network name may also be used to search the available WiFi network list 114. For example, the user-specified criteria 110 may also include the band, channel and/or type of security used by a WiFi network 104.

In an implementation, a user may enter the user-specified criteria 110 into the search option 108 of the WiFi UI 106. For example, a user may enter one or more letters of a network name for which the user wants to search. The search option 108 may enable a user to enter user-specified criteria 110. The search option 108 may include one or more graphical user interface (GUI) elements in which the user may enter the user-specified criteria 110. For example, the search option 108 may include one or more text boxes. Other GUI elements that may be included in the search option 108 include check boxes, buttons, sliders, droplists, etc.

The wireless communication device 102 may detect a user request for a search. In an implementation, when a user enters the user-specified criteria 110 into the search option 108 of the WiFi UI 106, this may trigger a user request for a search of the available WiFi network list 114.

The wireless communication device 102 may include a WiFi network search module 116. The WiFi network search module 116 may be implemented as part of the WiFi UI 106 (as depicted in FIG. 1). Alternatively, the WiFi network search module 116 may be separate from the WiFi UI 106.

The WiFi network search module 116 may search the available WiFi network list 114 found during a most recent scan based on the user-specified criteria 110. For example, the WiFi network search module 116 may filter WiFi networks 104 in the available WiFi network list 114 to remove those that do not satisfy the one or more user-specified criteria 110.

In a case where the user-specified criteria 110 include the network name, the WiFi network search module 116 may filter out WiFi networks 104 in the available WiFi network list 114 that do not include a string of text provided in the WiFi UI 106. For example, if a user enters the string “aa”, the WiFi network search module 116 may filter out any WiFi networks 104 in the available WiFi network list 114 that do not have the string “aa” in their network name. In an implementation, the text string to be searched may be at the beginning of the network name. In another implementation, the text string to be searched may occur anywhere in the network name.

As described above, the user-specified criteria 110 may include a parameter or property other than network name. The user may search for a keyword or value for other parameters associated with a WiFi network 104. For example, the user-specified criteria 110 may include a keyword for a security type (e.g., open network, WEP, WPA, etc.). In another example, the user-specified criteria 110 may include a value for WiFi network 104 channel or band to search.

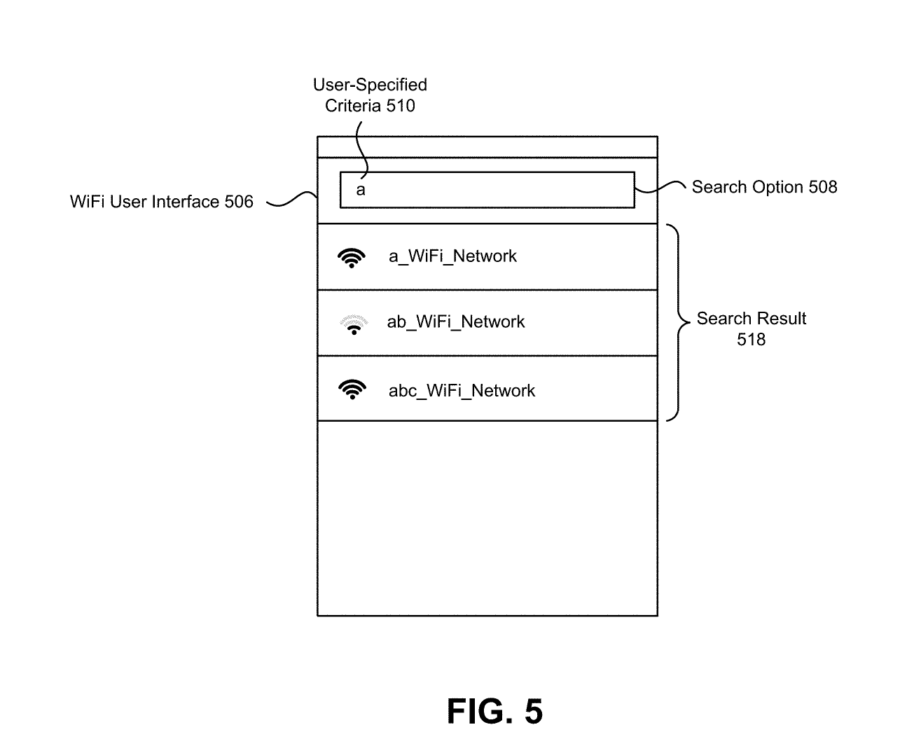

The wireless communication device 102 may display the search result 118 in the WiFi UI 106. For example, the WiFi network search module 116 may include all WiFi networks 104 in the available WiFi network list 114 that satisfy the one or more user-specified criteria 110 in the search result 118. The WiFi network search module 116 may provide the search result 118 to the WiFi UI 106. An example of the display of the search result 118 in the WiFi UI 106 is described in connection with FIG. 5.

There are at least three approaches for implementing the search option 108. In a first approach, the wireless communication device 102 may implement a static search using the current available WiFi network list 114. In this approach, upon detecting a user request for a search, the WiFi network search module 116 may obtain the available WiFi network list 114 generated during the most recent scan. The WiFi network search module 116 may then search this available WiFi network list 114 based on the user-specified criteria 110. In this approach, the search is static in the sense that the WiFi network search module 116 uses a prior available WiFi network list 114.

In a second approach, the wireless communication device 102 may implement a dynamic search that initiates a new scan. In this approach, the wireless communication device 102 may initiate a new scan for available WiFi networks 104 in response to detecting the user request for the search. For example, upon detecting a user request for a search in the WiFi UI 106, the WiFi network search module 116 may invoke the supplicant entity 120 to trigger the new scan.

During the new scan, the WiFi network scanner 112 may generate a new available WiFi network list 114. The WiFi network search module 116 may then search this new available WiFi network list 114 based on the user-specified criteria 110. The search result 118 may then be displayed. It should be noted that the results of the new scan may be more accurate than the prior scan due to changing WiFi network 104 conditions. For example, the wireless communication device 102 may move from one location to another, which may result in different WiFi networks 104 being available.

In a third approach, the wireless communication device 102 may implement a dynamic search that does not initiate a new scan but refreshes the search result 118 when new scan results are available. In this approach, upon detecting a user request for a search, the WiFi network search module 116 may obtain the available WiFi network list 114 generated during the most recent scan, search the list 114 and display the search result 118, as described in the first approach.

At some later time, the WiFi network search module 116 may receive a notification that new scan results are available. For example, the supplicant entity 120 may initiate a periodic scan for WiFi networks 104 and a new available WiFi network list 114 may be generated. In an implementation, the WiFi UI 106 may instruct the supplicant entity 120 to notify the WiFi UI 106 whenever new scan results are available.

Upon receiving the notification of new scan results, the WiFi network search module 116 may refresh the search result 118 based on the new scan results. For example, the WiFi network search module 116 may search the new available WiFi network list 114. The new search result 118 may be displayed in the WiFi UI 106. This approach provides an automatic refresh based on externally-triggered scan results, rather than initiating another scan (as described in the second approach). One benefit of this third approach is providing more accurate results when a user takes a long time to select a WiFi network 104 displayed in the search result 118. The WiFi networks 104 presented to the user will be refreshed to reflect more current network conditions.

The systems and methods described herein provide a beneficial search option 108 to the WiFi UI 106. A user will be able to search for a WiFi network 104 in a consistent and configurable manner. In addition to searching by network name, the user can search for other parameters or properties of the WiFi network 104 in which the user is interested. The search option 108 will improve user experience. Furthermore, the search option 108 may also improve network security due to the user being able to search for WiFi networks 104 based on security type. Additionally, the search option 108 may also improve wireless communication performance due to the user being able to search for certain channels and/or bands that may offer better performance or less interference.

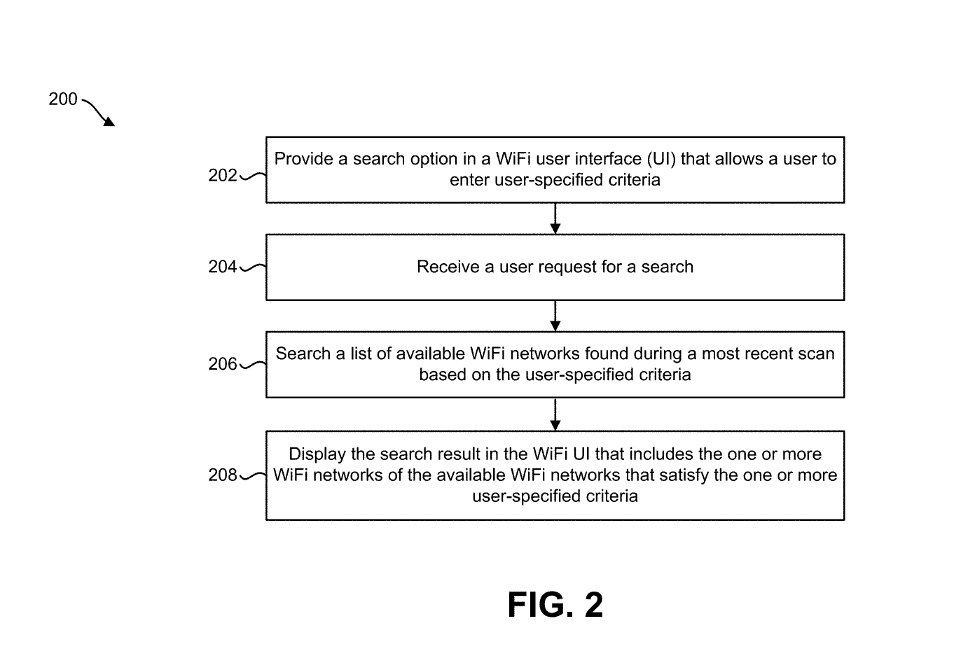

FIG. 2 is a flow diagram illustrating one configuration of a method 200 for providing a network search option 108. The method 200 may be performed by a wireless communication device 102. In an implementation, the wireless communication device 102 may be configured to communicate according to WiFi (e.g., WLAN) protocols.

The wireless communication device 102 may provide 202 a search option in a WiFi user interface (UI) 106. The search option 108 may allow a user to search for one or more available WiFi networks 104 that satisfy one or more user-specified criteria 110.

In one implementation, the user-specified criteria 110 may include a network name or a portion thereof. For example, the user may enter one or more characters of a network name into the search option 108 of the WiFi UI 106. The network name may be an SSID of a WiFi network 104.

In another implementation, the user-specified criteria 110 may include a parameter other than a network name. For example, the user-specified criteria 110 may include at least one of a band, a channel or a type of security used by a WiFi network 104. In this case, the user-specified criteria 110 may include a keyword or value associated with the WiFi network 104 parameter.

The wireless communication device 102 may receive 204 a user request for a search via the WiFi UI 106 search option 108. For example, upon a user first entering user-specified criteria 110 into the search option 108, the wireless communication device 102 may receive 204 the user request to search for WiFi networks 104. In another implementation, the wireless communication device 102 may receive 204 a user request for a search after the user enters all of the user-specified criteria 110 and then initiates the search (by pressing a search button, for instance).

The wireless communication device 102 may search 206 a list 114 of available WiFi networks 104 found during a most recent scan based on the user-specified criteria 110. In a first approach, the wireless communication device 102 may obtain the available WiFi network list 114 generated during the most recent scan. The wireless communication device 102 may then search 206 this available WiFi network list 114 based on the user-specified criteria 110. For example, the wireless communication device 102 may filter out WiFi networks 104 in the available WiFi network list 114 that do not satisfy the one or more user-specified criteria 110.

In a second approach, the wireless communication device 102 may initiate a new scan for available WiFi networks 104 in response to receiving 204 the user request for the search. The wireless communication device 102 may then search 206 an available WiFi network list 114 generated during the new scan.

In a third approach, the wireless communication device 102 may search 206 the available WiFi network list 114 generated during the most recent scan. At a later time, the wireless communication device 102 may receive a notification that new scan results are available. For example, the wireless communication device 102 may periodically perform another scan. The wireless communication device 102 may refresh the search result 118 by searching 206 the new available WiFi network list 114 based on the new scan results.

The wireless communication device 102 may display 208 the search result 118 in the WiFi UI 106. The search result 118 may include the one or more WiFi networks 104 of the available WiFi networks 104 that satisfy the one or more user-specified criteria 110.

FIG. 3 is an example illustrating a configuration of a WiFi user interface (UI) 306. The WiFi UI 306 may be displayed on the wireless communication device 102. In this example, the WiFi UI 306 includes a slider GUI element 322 that enables the user to turn WiFi communication on/off.

The WiFi UI 306 also displays the available WiFi network list 314 found during the most recent scan. In this example, the first WiFi network 104 in the available WiFi network list 314 has a network name 328 of “XYZ_WiFi_Network.” This network name 328 may be the SSID broadcast by that particular WiFi network 104.

In addition to the network name 328, the WiFi UI 306 may display a signal strength indication 324. A security symbol 326 may indicate whether a WiFi network 104 is secured or open.

The WiFi UI 306 may indicate the WiFi network 104 to which the wireless communication device 102 is currently connected. In this example, the wireless communication device 102 is currently connected to the “XYZ_WiFi_Network.” The WiFi UI 306 displays “Connected” in the WiFi UI 306 for the “XYZ_WiFi_Network” to indicate this network's connected status. The WiFi UI 306 may also list the connected network first in the available WiFi network list 314.

In an implementation, the remaining (i.e., non-connected) WiFi networks 104 in the available WiFi network list 314 may be listed according to signal strength. In another implementation, the remaining WiFi networks 104 in the available WiFi network list 314 may be listed alphabetically.

As can be observed in this example, it may be difficult and cumbersome for a user to find a particular WiFi network 104 within the available WiFi network list 314 as displayed on the WiFi UI 306. In this case, the WiFi networks 104 are displayed according to signal strength, which may make finding a particular WiFi network 104 difficult. This is especially problematic in a WiFi context where WiFi network 104 signal strength may change due to interference and/or mobility of the wireless communication device 102.

Listing the WiFi networks 104 alphabetically according to network name 328 may also present challenges to a user. As the number of WiFi networks 104 increases, the available WiFi network list 314 may include a large number of WiFi networks 104. Even listed alphabetically, the user would have to read through this large number of WiFi networks 104 to find a desired WiFi network 104.

Furthermore, the user may wish to find a WiFi network 104 based on part of a network name 328 that is not at the beginning of the network name 328. In this case, listing the WiFi networks 104 alphabetically in the available WiFi network list 314 would not help the user find a desired WiFi network 104.

Additionally, the user may wish to search for a WiFi network 104 based on a parameter other than network name 328. For example, the user may wish to find a WiFi network 104 that uses a particular band (e.g., 5G), a WAP that is operating on a particular channel or a WiFi network 104 that uses a particular type of security. As observed in this discussion, providing a search option 108 in the WiFi UI 306 may be beneficial.

FIG. 4 is an example illustrating a configuration of a WiFi user interface (UI) 406 with a search option 408. The WiFi UI 406 may be implemented as described in connection with the WiFi UI 306 of FIG. 3. For example, the WiFi UI 406 may display information about available WiFi networks 104 in an available WiFi network list 414.

The search option 408 may be added to the WiFi UI 406. The search option 408 may allow the user to enter user-specified criteria 110 to search the available WiFi network list 414. It should be noted that the example shown in FIG. 4 illustrates a pre-search state. In other words, the search option 408 is provided in the WiFi UI 406 to allow a user to select whether to perform an optional search for a WiFi network 104. An example of the search result 118 produced according to the systems and methods described herein is described in connection with FIG. 5.

In an implementation, the search option 408 may be a GUI element (e.g., button), which when selected, may provide additional GUI elements in which a user may enter the user-specified criteria 110. For example, when the search option 408 is selected a text box may be displayed in which a text string may be entered.

In another implementation, the search option 408 may be the GUI element in which a user may enter the user-specified criteria 110. For example, the search option 408 may be a text box displayed in the WiFi UI 406. Upon entering text into the text box, the wireless communication device 102 may initiate a search of the available WiFi network list 414 based on the text entered into the text box.

The search option 408 may also enable the user to search for a WiFi network 104 based on a parameter other than network name. The search option 408 may allow the user to enter keywords or values associated with parameters or properties other than the network name. For example, the search option 408 may allow the user to search according a particular radio frequency band, a particular channel or a particular type of security.

FIG. 5 is an example illustrating another configuration of a WiFi user interface (UI) 506 with a search option 508. The WiFi UI 506 may be implemented as described in connection with the WiFi UI 406 of FIG. 4.

Upon selecting the search option 508 (as described in connection with FIG. 4), the WiFi UI 506 may display a text box in which the user may enter user-specified criteria 510. In this example, the search option 508 is configured to search the available WiFi network list 414 according to the network name. Therefore, the text entered into the text box may be used to filter the available WiFi network list 414 according to network name.

In this example, the letter “a” is entered into the search option 508. As such, the letter “a” is the user-specified criteria 510. The wireless communication device 102 filters WiFi networks 104 from the available WiFi network list 414 that do not satisfy the user-specified criteria 510.

The WiFi UI 506 displays the search result 518. In this case, the three WiFi networks 104 with the letter “a” in their network name are displayed. The other WiFi networks 104 in the available WiFi network list 414 that do not include the letter “a” are left out of the search result 518.

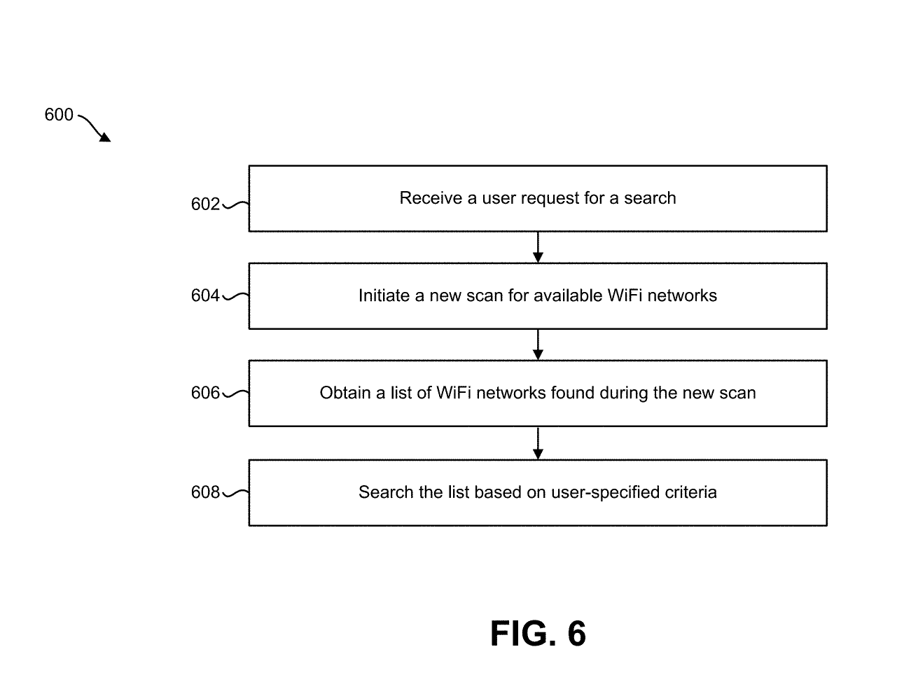

FIG. 6 is a flow diagram illustrating another configuration of a method 600 for providing a network search option 108. The method 600 may be performed by a wireless communication device 102. In an implementation, the wireless communication device 102 may be configured to communicate according to WiFi (e.g., WLAN) protocols. The wireless communication device 102 may include a WiFi UI 106 that is configured with a search option 108.

The wireless communication device 102 may receive 602 a user request for a search. For example, upon a user entering user-specified criteria 110 into the search option 108, the wireless communication device 102 may receive 602 the user request to search for WiFi networks 104.

The wireless communication device 102 may initiate 604 a new scan for available WiFi networks 104. For example, the wireless communication device 102 may invoke the supplicant entity 120 to trigger the new scan. This may be done as described in connection with FIG. 1.

The wireless communication device 102 may obtain 606 a list 114 of WiFi networks 104 found during the new scan. During the new scan, the wireless communication device 102 may identify one or more available WiFi networks 104. The wireless communication device 102 may include these available WiFi networks 104 in a new available WiFi network list 114.

The wireless communication device 102 may search 608 the new available WiFi network list 114 based on the user-specified criteria 110. For example, the wireless communication device 102 may filter out WiFi networks 104 in the available WiFi network list 114 that do not satisfy the one or more user-specified criteria 110. The wireless communication device 102 may display the search result 118 in the WiFi UI 106.

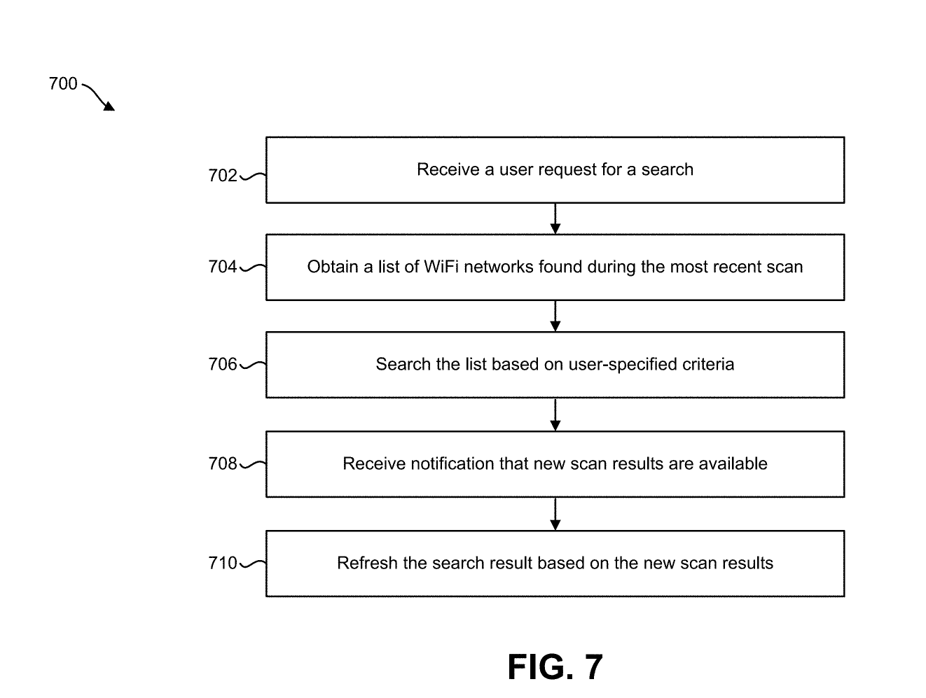

FIG. 7 is a flow diagram illustrating yet another configuration of a method 700 for providing a network search option 108. The method 700 may be performed by a wireless communication device 102. In an implementation, the wireless communication device 102 may be configured to communicate according to WiFi (e.g., WLAN) protocols. The wireless communication device 102 may include a WiFi UI 106 that is configured with a search option 108.

The wireless communication device 102 may receive 702 a user request for a search. For example, upon a user entering user-specified criteria 110 into the search option 108, the wireless communication device 102 may receive 702 the user request to search for WiFi networks 104.

The wireless communication device 102 may obtain 704 a list 114 of WiFi networks 104 found during the most recent scan. For example, the wireless communication device 102 may periodically perform a scan for WiFi networks 104. In an implementation, the supplicant entity 120 may be configured to periodically trigger a network scan. During the most recent scan, the wireless communication device 102 may generate an available WiFi network list 114.

The wireless communication device 102 may search 706 the available WiFi network list 114 based on the user-specified criteria 110. For example, the wireless communication device 102 may filter out WiFi networks 104 in the available WiFi network list 114 that do not satisfy the one or more user-specified criteria 110. The wireless communication device 102 may display the search result 118 in the WiFi UI 106.

The wireless communication device 102 may receive 708 a notification that new scan results are available. For example, the supplicant entity 120 may initiate a periodic scan for WiFi networks 104 after the first search 706 is performed. During this new scan, the wireless communication device 102 may generate a new available WiFi network list 114. In an implementation, the supplicant entity 120 may provide the notification of the new scan results to the WiFi UI 106.

The wireless communication device 102 may refresh 710 the search result 118 based on the new scan results. For example, the wireless communication device 102 may search the new available WiFi network list 114 based on the user-specified criteria 110. The wireless communication device 102 may then display the updated search result 118 in the WiFi UI 106.

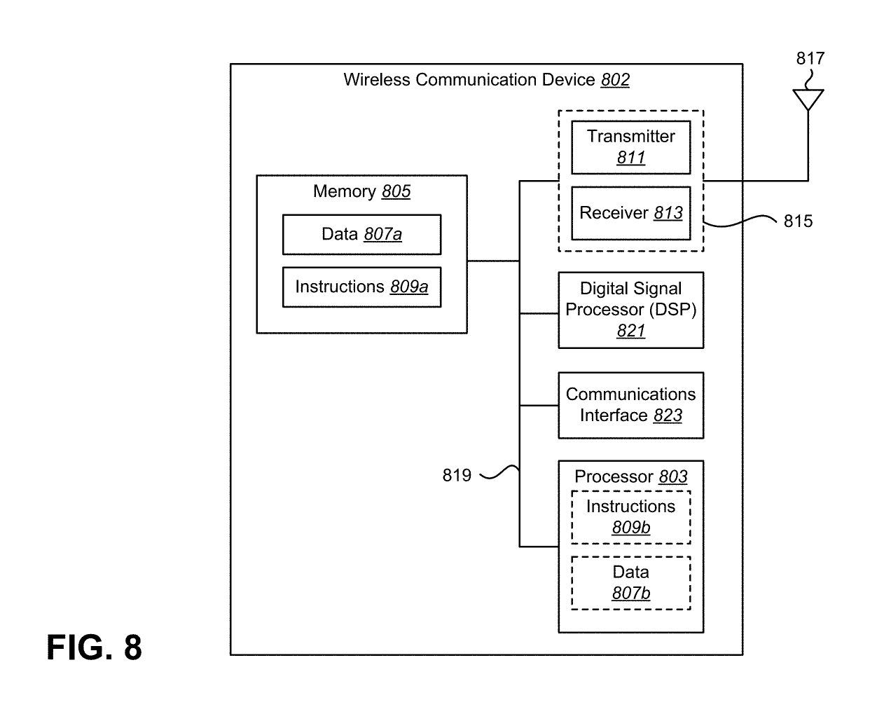

FIG. 8 illustrates certain components that may be included within a wireless communication device 802. The wireless communication device 802 described in connection with FIG. 8 may be an example of and/or may be implemented in accordance with the wireless communication device 102 described in connection with one or more of FIGS. 1-7.

The wireless communication device 802 includes a processor 803. The processor 803 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 803 may be referred to as a central processing unit (CPU). Although just a single processor 803 is shown in the wireless communication device 802 of FIG. 8, in an alternative configuration, a combination of processors (e.g., an ARM and DSP) could be used.

The wireless communication device 802 also includes memory 805 in electronic communication with the processor (i.e., the processor can read information from and/or write information to the memory). The memory 805 may be any electronic component capable of storing electronic information. The memory 805 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions may include one or more programs, routines, sub-routines, functions, procedures, code, etc. The instructions may include a single computer-readable statement or many computer-readable statements. The instructions 809a may be executable by the processor 803 to implement the methods disclosed herein. Executing the instructions 809a may involve the use of the data 807a that is stored in the memory 805. When the processor 803 executes the instructions 809, various portions of the instructions 809b may be loaded onto the processor 803, and various pieces of data 807b may be loaded onto the processor 803.

The wireless communication device 802 may also include a transmitter 811 and a receiver 813 to allow transmission and reception of signals to and from the wireless communication device 802 via an antenna 817. The transmitter 811 and receiver 813 may be collectively referred to as a transceiver 815. The wireless communication device 802 may also include (not shown) multiple transmitters, multiple antennas, multiple receivers and/or multiple transceivers.

The wireless communication device 802 may include a digital signal processor (DSP) 821. The wireless communication device 802 may also include a communications interface 823. The communications interface 823 may allow a user to interact with the wireless communication device 802.

The various components of the wireless communication device 802 may be coupled together by one or more buses, which may include a power bus, a control signal bus, a status signal bus, a data bus, etc. For the sake of clarity, the various buses are illustrated in FIG. 8 as a bus system 819.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It should be noted that one or more of the features, functions, procedures, components, elements, structures, etc., described in connection with any one of the configurations described herein may be combined with one or more of the functions, procedures, components, elements, structures, etc., described in connection with any of the other configurations described herein, where compatible. In other words, any compatible combination of the functions, procedures, components, elements, etc., described herein may be implemented in accordance with the systems and methods disclosed herein.

The functions described herein may be stored as one or more instructions on a processor-readable or computer-readable medium. The term “computer-readable medium” refers to any available medium that can be accessed by a computer or processor. By way of example, and not limitation, such a medium may comprise Random-Access Memory (RAM), Read-Only Memory (ROM), Electrically Erasable Programmable Read-Only Memory (EEPROM), flash memory, Compact Disc Read-Only Memory (CD-ROM) or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc, where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method, comprising:
receiving a user request for a search via a WiFi user interface (UI) search option that facilitates searches for one or more available WiFi networks satisfying one or more user-specified criteria;
searching with the WiFi UI search option a list of available WiFi networks found during a most recent scan based on the user-specified criteria; and
displaying with the WiFi UI a search result comprising one or more WiFi networks of the available WiFi networks that satisfy the one or more user-specified criteria.

2. The method of claim 1, further comprising initiating a new scan for available WiFi networks in response to receiving the user request for the search.

3. The method of claim 2, wherein searching the list of available WiFi networks found during a most recent scan comprises searching a list of available WiFi networks found during the new scan initiated by the user request for the search.

4. The method of claim 2, wherein initiating the new scan comprises invoking a supplicant entity of a WiFi-enabled wireless communication device to trigger the new scan.

5. The method of claim 1, further comprising:
receiving at the WiFi UI a notification that new scan results are available; and
refreshing the search result based on the new scan results.

6. The method of claim 1, wherein the user-specified criteria include a network name.

7. The method of claim 1, wherein the user-specified criteria include at least one of a band, a channel or a type of security used by a WiFi network.

8. The method of claim 1, wherein searching the list of available WiFi networks based on the user-specified criteria comprises filtering WiFi networks in the list of available WiFi networks to remove those that do not satisfy the one or more user-specified criteria.

9. A wireless communication device, comprising:
a processor;
a memory in communication with the processor; and
instructions stored in the memory, the instructions executable by the processor to:
receive a user request for a search via a WiFi user interface (UI) search option that facilitates searches for one or more available WiFi networks satisfying one or more user-specified criteria;
search with the WiFi UI search option a list of available WiFi networks found during a most recent scan based on the user-specified criteria; and
display with the WiFi UI a search result comprising one or more WiFi networks of the available WiFi networks that satisfy the one or more user-specified criteria.

10. The wireless communication device of claim 9, further comprising instructions executable to initiate a new scan for available WiFi networks in response to receiving the user request for the search.

11. The wireless communication device of claim 10, wherein the instructions executable to search the list of available WiFi networks found during a most recent scan comprise instructions executable to search a list of available WiFi networks found during the new scan initiated by the user request for the search.

12. The wireless communication device of claim 9, further comprising instructions executable to:
receive at the WiFi UI a notification that new scan results are available; and
refresh the search result based on the new scan results.

13. The wireless communication device of claim 9, wherein the user-specified criteria include a network name.

14. The wireless communication device of claim 9, wherein the user-specified criteria include at least one of a band, a channel or a type of security used by a WiFi network.

15. The wireless communication device of claim 9, wherein the instructions executable to search the list of available WiFi networks based on the user-specified criteria comprise instructions executable to filter WiFi networks in the list of available WiFi networks to remove those that do not satisfy the one or more user-specified criteria.

16. A computer-program product for wireless communications, the computer-program product comprising a non-transitory computer-readable medium having instructions thereon, the instructions comprising:
code for causing a wireless communication device to receive a user request for a search via a WiFi user interface (UI) search option that facilitates searches for one or more available WiFi networks satisfying one or more user-specified criteria;
code for causing the wireless communication device to search with the WiFi UI search option a list of available WiFi networks found during a most recent scan based on the user-specified criteria; and
code for causing the wireless communication device to display with the WiFi UI a search result comprising one or more WiFi networks of the available WiFi networks that satisfy the one or more user-specified criteria.

17. The computer-program product of claim 16, further comprising code for causing the wireless communication device to initiate a new scan for available WiFi networks in response to receiving the user request for the search.

18. The computer-program product of claim 17, wherein the code for causing the wireless communication device to search the list of available WiFi networks found during a most recent scan comprises code for causing the wireless communication device to search a list of available WiFi networks found during the new scan initiated by the user request for the search.

19. The computer-program product of claim 16, further comprising:
code for causing the wireless communication device to receive at the WiFi UI a notification that new scan results are available; and
code for causing the wireless communication device to refresh the search result based on the new scan results.

20. The computer-program product of claim 16, wherein the code for causing the wireless communication device to search the list of available WiFi networks based on the user-specified criteria comprises code for causing the wireless communication device to filter WiFi networks in the list of available WiFi networks to remove those that do not satisfy the one or more user-specified criteria.
